(19) United States
(12) Patent Application Publication
(10) Pub. No.: US 2014/0032271 A1
(43) Pub. Date: Jan. 30, 2014

(54) SYSTEM AND METHOD FOR PROCESSING DEMOGRAPHIC DATA

(71) Applicant: Environmental Systems Research Institute (ESRI), Redlands, CA (US)

(72) Inventor: Earl Nordstrand, Redlands, CA (US)

(73) Assignee: Environmental Systems Research Institute (ESRI), Redlands, CA (US)

(21) Appl. No.: 13/947,988

(22) Filed: Jul. 22, 2013

Related U.S. Application Data
(60) Provisional application No. 61/674,259, filed on Jul. 20, 2012.

(51) Int. Cl. G06Q 30/02

(52) U.S. Cl. CPC G06Q 30/0205
USPC 705/7.34

(57) ABSTRACT

Embodiments relate to a computer-implemented method comprising a process of receiving geographic data corresponding to a geographic area, receiving population data corresponding to a population of the geographic area, and generating a distribution of the population over the geographic area based on characteristics of geographic features of the geographic area. Characteristics of the geographic features can be classified into one or more usage categories corresponding to an estimated populated density associated with the particular geographic feature. A grid can be generated to overlay the geographic area, and the distribution of the population to an area encapsulated within each of the plurality of grid cells can be interpolated based on the usage categories of the geographic features and a position of the geographic features with respect to each of the plurality of grid cells.

### CROSS-REFERENCES TO RELATED APPLICATIONS

The present non-provisional application claims benefit under 35 U.S.C. §120 of U.S. Provisional Patent Application No. 61/674,259, filed on Jul. 20, 2012, and entitled “System and Method for Processing Demographic Data,” which is herein incorporated by reference in its entirety for all purposes.

### BACKGROUND

Current human geography data bases may be created with both unique attributes and unique geographic scales. Some of this uniqueness derives from the methods used by national and international agencies in their collection of the underlying data. A normalized global data base typically includes demographics like population, housing unit, business and economic information that may be used to determine societal characteristics at any desired scale from macro to micro-levels. Such data and technology integration has the potential to create a useful multi-state data structure that provides users with both aggregation and disaggregation of the underlying data for meaningful mapping, reporting, and decision support. However, the disparity in attributes and scale across data sources has made processing and integration an unwieldy and impractical endeavor.

### BRIEF SUMMARY

Embodiments of the invention are related to a computer-implemented method comprising a process of receiving geographic data corresponding to a geographic area, receiving population data corresponding to a population of the geographic area, and generating a distribution of the population over the geographic area based on characteristics of geographic features of the geographic area. Characteristics of the geographic features can be classified into one or more usage categories, where the usage categories correspond to an estimated populated density associated with the particular geographic feature.

In some embodiments, the distribution of the population over the geographic area can be displayed within a grid network of any suitable resolution. The method further includes generating a grid configured to overlay the geographic area, where the grid includes a plurality of grid lines forming a plurality of grid cells there between, and interpolating a distribution of the population to an area encapsulated within each of the plurality of grid cells based on the usage categories of the geographic features and a position of the geographic features with respect to each of the plurality of grid cells. The population within each grid cell can be represented by a point with a size that is proportional to a magnitude of the population within the particular grid cell.

In further embodiments, the method can further include receiving road-based data including a location and density of a plurality of roads within the geographic area. In such cases, interpolating a distribution of the population to an area encapsulated within each of the plurality of grid cells can be further based on the location and density of the plurality of roads with respect to each of the plurality of grid cells. In certain implementations, the method further includes assigning a first weighted value to one or more of the geographic features, and assigning a second weighted value to the plurality of roads, where interpolating the distribution of the population can further be based on the associated weighted values of the geographic features and the plurality of roads.

In yet further embodiments, the method can further include receiving commercial activity data indicating intensities of commercial activity within the geographic area. In such cases, interpolating a distribution of the population to an area encapsulated within each of the plurality of grid cells can further be based on both a location and intensity of commercial activity with respect to each of the plurality of grid cells. A third weighted value can be assigned to the commercial activity and factored into the interpolation of the population distribution for the geographic area. More generally, the method can include receiving demographic data that indicates an intensity of a population demographic over the geographic area, where interpolating a distribution of the population to an area encapsulated within each of the plurality of grid cells is further based on both a location and intensity of demographic with respect to each of the plurality of grid cells. In some aspects, the population demographic can include gender, race, age, disabilities, mobility, home ownership, employment status, income level, average spending, or any suitable demographic and distribution thereof.

In certain embodiments, the present invention includes a system and method for determining a numerical solution to any of a set of complex algorithms that calculate a particular discrete subset of a larger data set where the calculated particular subset equates to the localized portion of the larger data set. For example, this may include processing data for improving the accuracy and consistency of summarizing and mapping socio-demographic data to provide consistent results for all types of statistical units and all types of statistical data on a global scale.

In some cases, the system and method includes receiving a first data set representing a geographic area, creating a grid configured to overlay the geographic area, the grid comprising a plurality of grid lines forming a plurality of grid cells there between, and receiving a second data set comprising information particular to the geographic area. The method further includes associating a specific portion of the second data set to an area encapsulated within each of the plurality of grid cells based on one or more characteristics of the information particular to the geographic area, which can be performed by executing remote imagery interpolation routines. Each of the plurality of grid cells can be assigned a weighted value, where a magnitude for each of the weighted values is based upon the specific portion of the second data set associated with that particular grid cell.

In further embodiments, the second data set can be social or demographic data. Some embodiments can include demographic data such as one or more of gender, race, age, disabilities, mobility, home ownership, employment status, location, population, income level, as well as business and economic information. In other cases, the second data set can be scientific data, including medical data, temperature data, environmental data, disease occurrence data, radiation data, pollution data, and the like.

### BRIEF DESCRIPTION OF THE DRAWINGS

FIG. 1 is a simplified flow diagram illustrating a method for generating a distribution of a population over a geographic area, according to an embodiment of the invention.

FIG. 2 depicts graphical data illustrating a distribution of a population over a given geographic area, according to an embodiment of the invention.

FIG. 3 depicts graphical data illustrating a distribution of population superimposed on a feature-laden geographic area, according to an embodiment of the invention.

FIG. 4 illustrates a dasymetric surface map created by a combination of image analysis and demographic data, according to an embodiment of the invention.

FIG. 5 is a simplified flow diagram illustrating a process for creating a dasymetric surface map depicting a distribution of a population over a geographic area, according to an embodiment of the invention.

FIG. 6 is a simplified flow diagram illustrating a method of generating a distribution of a population over a geographic area using geographic features, a grid road network, and commercial activity, according to an embodiment of the invention.

FIG. 7 is a detailed flow diagram illustrating a method of generating a distribution of a population over a geographic area using geographic features, a grid road network, and commercial activity, according to an embodiment of the invention.

FIG. 8 illustrates a computer system, according to an embodiment of the invention.

FIG. 9 depicts a simplified diagram of a distributed system for providing a system and method for generating a distribution of a population over a geographic area, according to an embodiment of the invention.

### DETAILED DESCRIPTION

Embodiments of the invention relate to a system and method to incorporate image data, demographic data, business data and other social and demographic information into a useful multi-scale data structure that allows aggregation and disaggregation of data for meaningful mapping, reporting and decision support.

Socio-demographic data can be a valuable asset for business and societal decision making Describing the human geography of the world requires tools to assimilate data in a statistically valid way that will allow meaningful decision making There are no standards for data collection and no universal tools to create useful data available in a commercial system. The underlying technology of Geographic Information Systems (GIS) and the capability to effectively process and analyze large volumes of data can make it feasible to create a useable, global decision support data base.

According to certain embodiments, two data components can be used to create such solutions. The first data component can be a data set comprising a collection of social and demographic characteristics for a human population (e.g., a population). In many cases, a more complete and accurate data set can yield a more accurate analysis. The data set should be of appropriate breadth to cover the entire scope of the underlying data questions. For issues of a global scale, a global data set is typically preferred, while data aggregations at a regional level may utilize data limited to the scope of that region while still maintaining an acceptable accuracy. Those of ordinary skill in the art (e.g., geographic information system (GIS) professionals) would appreciate that the requirements for various data sets may change depending on the scope, resolution, and accuracy required for a given application.

In some embodiments, the second data component can be a gridded surface of the world, continent, region, or some subset thereof, that can be used to predict the likelihood and density of the characteristics of the first data set (e.g., population) along each point, region, etc., of the gridded surface. In some cases, the gridded surface can be constructed from multiple datasets that can contribute to the accuracy of an aggregation/disaggregation approach. That is, certain implementations may utilize imagery, roads, and business information to create a likelihood surface. For example, by analyzing geographic imagery (i.e., geographic features), the location and distribution of roads within the given geography, and business information associated with a given geography, one can interpolate a likely distribution of a demographic (point-data based population) within the given geography. For instance, certain geographic features (e.g., bodies of water, land with steep gradients, etc.) may be likely to have a sparse population. On the other hand, geographic features like artificial structures (e.g., buildings) or plains may be highly likely to have dense populations. Furthermore, geographic areas with a high road density or high commercial activity may also be more likely to have dense populations. Thus, geographic features, roads, commercial activity, and the like, can be used to estimate a likely population distribution within the given geographic area based on their various characteristics and the likelihood that a given population density would be congregated nearby, according to certain embodiments of the invention. The examples that follow are provided to further illustrate these aspects as well as alternative embodiments. However, it should be understood that many other embodiments and applications are possible, as would be appreciated by one of ordinary skill in the art with the benefit of this disclosure.

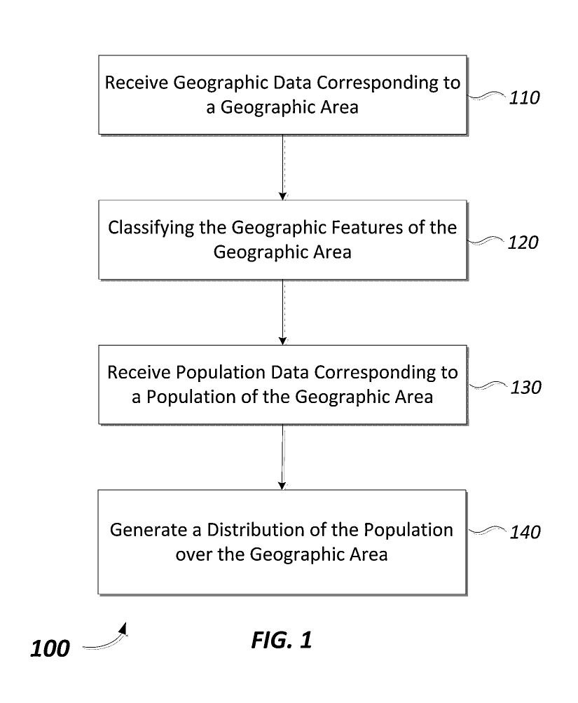

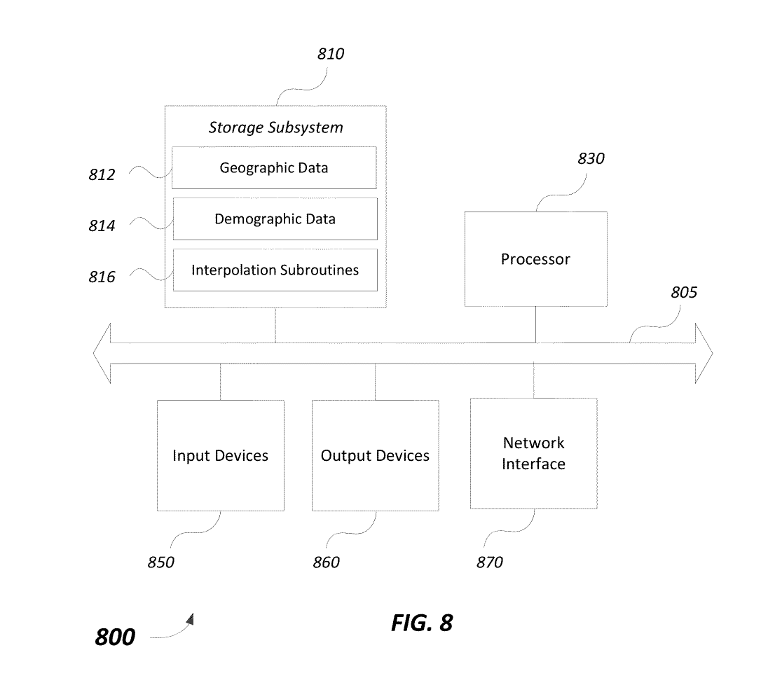

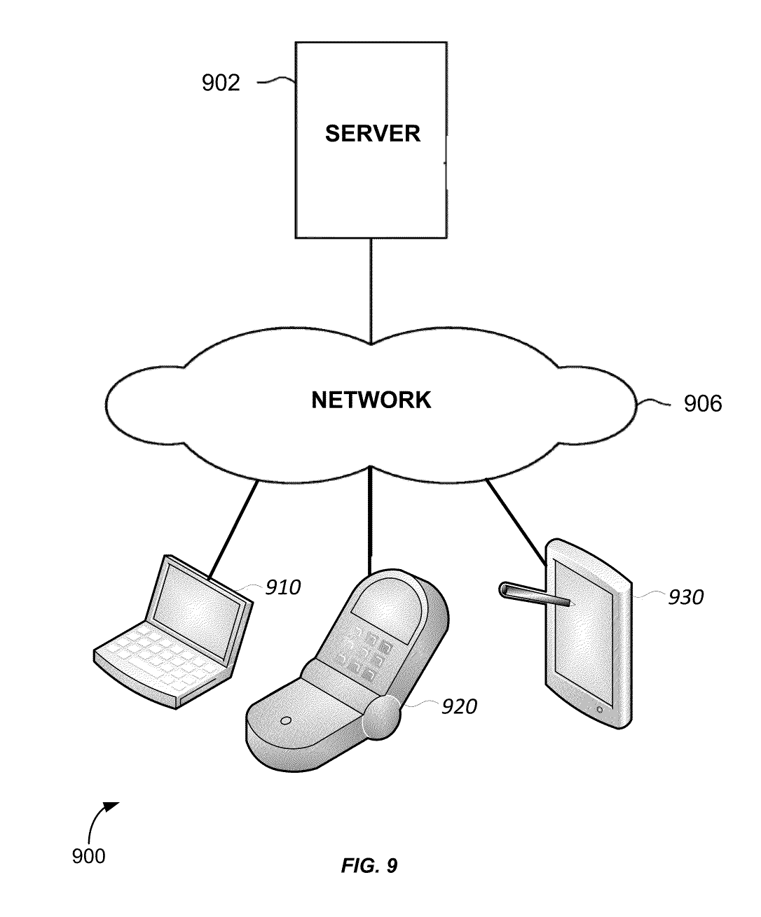

FIG. 1 depicts a simplified flow diagram illustrating aspects of a method 100 for generating a distribution of a population over a geographic area, according to an embodiment of the invention. Method 100 can be performed by processing logic that may comprise hardware (e.g., circuitry, dedicate logic, etc.), software (which as is run on a general purpose computing system or a dedicated machine), firmware (embedded software), or any combination thereof. In some embodiments, method 100 can be performed by elements of system 800 or system 900 of FIGS. 8 and 9 (e.g., processor 830).

At 110, method 100 begins with receiving geographic data corresponding to a geographic area. The geographic data can cover a geographic area of any suitable size including local, county, regional, and national levels. The geographic data can include geographic features within the geographic area, such as naturally occurring geographic features (e.g., bodies of water, mountains, plains, rivers, valleys, trees, etc.), man-made features and structures (e.g., buildings, parking lots, parks, landfills, etc.), or the like.

At 120, method 100 continues with classifying the geographic features within the geographic area into a number of usage categories. In some aspects, usage categories can be used to classify a likelihood that a person or a certain density of population would be associated with the given geographic area. For example, very few people would likely be located on a body of water or a mountain top. On the other hand, many people may be likely to be located in an area that has a high number of single family homes. In some cases, even more people may be associated with urban centers with a high density of multi-family structures (e.g., apartment complexes, condominiums, etc.). The assignment and application of usage categories to geographic features would be appreciated by one of ordinary skill in the art with the benefit of this disclosure.

At 130, method 100 continues with receiving population data corresponding to a population of the geographic area. In some cases, the population data can be point-data. For example, census data may associate a given population (e.g., 10000 people) over the entire geographic area or a portion thereof. However, population data can be presented in any suitable format (e.g., distribution, etc.) as needed.

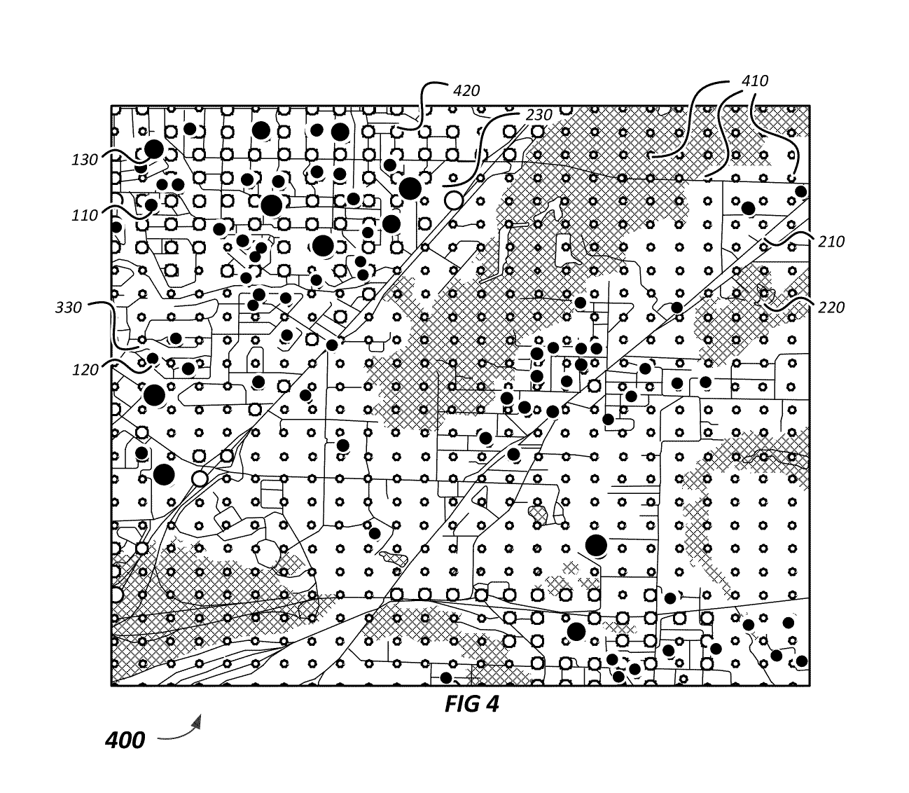

At 140, method 100 continues with interpolating and/or generating a distribution of the population over the geographic area based on the geographic features and their associated usage categories. In some embodiments, the distribution of the population can be represented on a gridded surface with proportionally sized markers indicating a population density, as shown in FIG. 4, and alternatively referred to as “NordyPoints” as further described below. The distribution of the population can be represented in any suitable format as would be appreciated by one of ordinary skill in the art with the benefit of this disclosure.

In some embodiments, additional layers of data can be used for increased interpolation accuracy. For example, road networks, commercial activity, zoning ordinance, and the like, can be used to more accurately determine where a population is more likely to be located. In some implementations, geographic features and road networks may be stronger indicators of population location than commercial activity and may be weighted accordingly when generating the distribution. However, any desired weight apportionment can be assigned to data layers as needed. In certain embodiments, the process of generating a distribution of a population over a geographic area can be described more broadly as disaggregating statistics associated with large polygons (e.g., population for county X) down to smaller polygons (e.g., population distribution for a subset of county X).

It should be appreciated that the specific steps illustrated in FIG. 1 provides a particular method of generating a distribution of a population over a geographic area, according to an embodiment of the present invention. Other sequences of steps may also be performed according to alternative embodiments. In certain embodiments, method 100 may perform the individual steps in a different order, at the same time, or any other sequence for a particular application. For example, alternative embodiments may include more data layers, differing weights, and/or different standards of determining usage categories. Moreover, the individual steps illustrated in FIG. 1 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method.

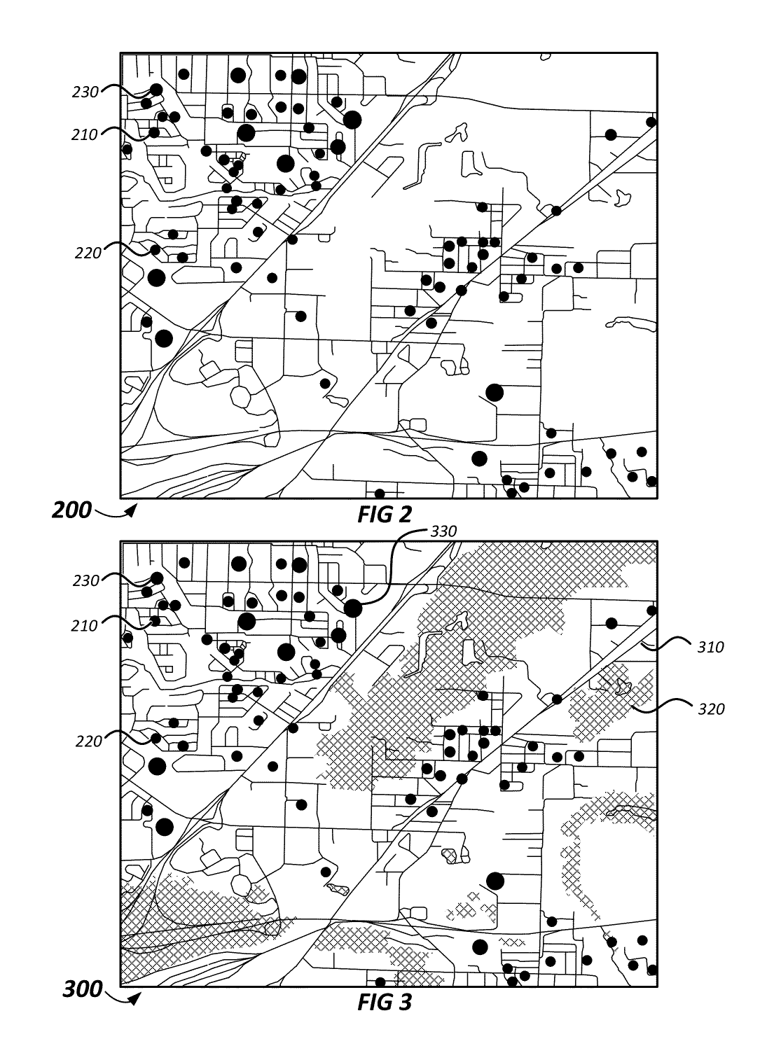

FIG. 2 depicts graphical data 200 illustrating a distribution of population over a given geographic area, according to an embodiment of the invention. The graphical data shows a number of points 210 of varying sizes to indicate certain relative population densities. At point 220, for example, the population density is relatively low with respect to point 210. Conversely, at point 230, the population density is relatively high with respect to point 210. In this particular example, the points 210 are population counts from the U.S. Census for the particular block (e.g., area) that they represent. The points 210 can be used to apportion other statistical data (e.g., median income, age, etc.).

FIG. 3 depicts graphical data 300 illustrating a distribution of population superimposed on a feature-laden geographic area. FIG. 3 includes population data (e.g., points 210, 220, 230) and geographic features (from geographic data) including roads 310, forest land 320, and urban areas 330 (e.g., buildings, etc.). One useful feature of FIG. 3 is that the image includes geographic features in image data that are detectable and can be used in the population distribution and interpolation algorithms described herein.

FIG. 4 illustrates a dasymetric surface map 400 created by a combination of image analysis and demographic data, according to an embodiment of the invention. As shown, map 400 includes population densities (i.e., 210, 220, 230), geographic features (roads 310, forest land 320, and urban areas 330), and a series of NordyPoints 410. The relative size of each point 410 corresponds to the concentration or density of the underlying data (e.g., demographic, scientific, etc.). For instance, where population density is high (e.g., point 130 and urban areas 230), NordyPoint 330 and many of the points around it are large as the population is interpolated for the surrounding area. Conversely, in areas of relatively low population (e.g., point 120 and surrounding forest land), the NordyPoints 330 around that region are relatively small.

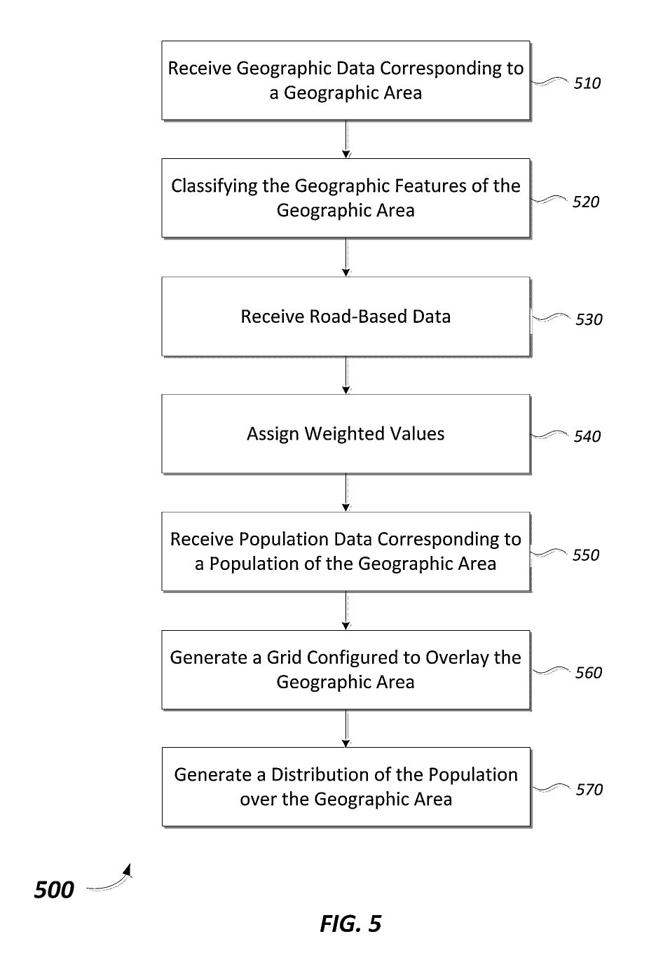

FIG. 5 is a simplified flow diagram illustrating a process for creating a dasymetric surface map depicting a distribution of a population over a geographic area, according to an embodiment of the invention. Method 500 can be performed by processing logic that may comprise hardware (e.g., circuitry, dedicate logic, etc.), software (which as is run on a general purpose computing system or a dedicated machine), firmware (embedded software), or any combination thereof. In some embodiments, method 500 can be performed by elements of system 800 and/or system 900 of FIGS. 8 and 9 (e.g., processor 830) or any combination thereof.

At 510, processor 830 receives geographic data corresponding to a geographic area. For example, the geographic area can include various features including roads, bodies of water, forestry, buildings, agricultural lands, commercial zones, industrial zones, residential zones, and the like.

At 520, processor 830 classifies the geographic features of the geographic area. In some embodiments, the geographic features are classified into a number of usage categories. In some aspects, usage categories can be used to classify a likelihood that certain population density would be associated with the given geographic area. For example, very few people would likely be located on a body of water or a mountain top. On the other hand, many people may be likely to be located in an area that has a high number of single family homes. In some cases, even more people may be associated with urban centers with a high density of multi-family structures (e.g., apartment complexes, condominiums, etc.). The appropriate assignment and application of usage categories to geographic features would be appreciated by one of ordinary skill in the art with the benefit of this disclosure.

At 530, processor 830 receives road-based data including a location and density of a plurality or network of roads within the geographic area. An “accessibility” can be assigned to portions of the road-based data based on a local density of the roads. In some aspects, a higher accessibility corresponds to areas of higher population density. Though this particular embodiment utilizes road-based data, other embodiments can use any type of social data, demographic data, etc., to add additional levels of accuracy in the resulting population distribution. For example, embodiments can include social or demographic data such as one or more of gender, race, age, disabilities, mobility, home ownership, employment status, location, population, income level, scientific data, including medical data, temperature data, environmental data, and the like. In some embodiments, zoning data can be used to more accurately classify geographic features within the geographic area. For example, zoning data may indicate that a group of buildings are zoned as residential buildings or industrial buildings, which may significantly impact a population distribution.

At 540, processor 830 assigns weighted values to the geographic data and the road-based data. In some aspects, geographic features may provide a greater accuracy for estimating a population distribution than road density and may be more heavily weighted as a consequence. Certain ancillary data (e.g., commercial data, income data, etc.) may be assigned a lower relative weight than road-based data because, although it may be useful for estimating a population distribution over a geographic area, but provides a relatively low accuracy. Allocating appropriate weights to the various layers of data (e.g., geographic data, road-based data, etc.) would be appreciated by one of ordinary skill in the art with the benefit of this disclosure.

At 550, processor 830 receives population data corresponding to a population within the geographic area. In some cases, the population data can be point-data. For example, census data may associate a given population (e.g., 10,000 people) over the entire geographic area or a portion thereof. However, population data can be presented in any suitable format (e.g., distribution, etc.) as needed. Typically, statistical data are attributes attached to polygons (e.g., geographic areas) defining the collection units for the statistics, as would be appreciated by one of ordinary skill in the art with the benefit of this disclosure.

At 560, processor 830 generates a grid configured to overlay the geographic area. The grid can comprise a number of grid lines forming a plurality of grid cells there between. For example, the grid lines may create a hatched pattern in the form of squares, rectangles, triangles, hexagons, or other suitable mesh of polygons. Alternatively, non-uniform boundaries can be created in any size or shape as needed.

At 570, processor 830 generates a distribution of the population over the geographic area based on the geographic features, the road-based data, and their associated weights and represents the distribution on the gridded “dasymetric” surface with proportionally sized markers indicating a population density, as shown in FIG. 4. The dasymetric surface provides an accurate representation of the likelihood of any point to contribute some proportion of a set of statistical attributes (e.g., population) for the enclosing polygon (e.g., geographic area). The distribution of the population can be represented in any suitable format as would be appreciated by one of ordinary skill in the art with the benefit of this disclosure. Furthermore, the spatial resolution for an effective implementation of this methodology would not need to be a uniform grid (e.g., see FIG. 4). For example, an urban area block resolution may require a 250 meter grid for sufficiently accurate resolution. In contrast, rural areas with fewer features and lower population densities may be adequately represented with a 1000 meter grid. The grid could vary in resolution depending upon the quality and quantity of ancillary information available.

In some embodiments, additional layers of data can be used for increased interpolation accuracy. For example, road networks, commercial activity, zoning ordinance, and the like, can be used to more accurately determine where a population is more likely to be located. Furthermore, better image processing may provide some indication or identification of residential areas, commercial areas, agricultural areas, industrial areas, forested areas, etc., which could increase the accuracy in the resulting population distribution calculations. In some cases, commercial activity may indicate daytime populations, rather than indicate the residence of the population. For example, people typically shop in commercial districts rather than residential districts. This fact may further improve the accuracy and inform as to a proper weight to assign commercial data is determining the population distribution relating to residence. In some implementations, geographic features and road networks may be stronger indicators of population location than commercial activity and may be weighted accordingly when generating the distribution. However, any desired weight apportionment can be assigned to data layers as needed and can be mapped or associated with a given geographic area by using, for example, remote imagery interpolation routines.

It should be appreciated that the specific steps illustrated in FIG. 5 provides a particular method 500 of processing demographic data, according to an embodiment of the present invention. Other sequences of steps may also be performed according to alternative embodiments. In certain embodiments, the method 500 may perform the individual steps in a different order, at the same time, or any other sequence for a particular application. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize and appreciate many variation, modification, and alternatives of the method.

Any suitable data source can be used to create the dasymetric distributions including Landsat Global Land Survey available as a single image service, Globcover global land cover map derived from MERIS, the imagery base map service, NAVTEQ street data, Open StreetMap, Delorme global datasets, Point of Interest and Business listing data, and Place datasets. In some embodiments, these datasets may need a geoprocessing model developed that can create the derived information that can be used in creating the weights and validation of the weights in the dasymetric distribution.

In certain embodiments, the principal analysis utilizes the Global Land Survey data to create the core dasymetric surface. This can require creating an approach to image classification that will result in the equivalent of an “intensity of human use” measurement. A normalized approach to this type of classification can allow the creation of different weights for different categories of socio-economic statistics. A basic approach can be built and refined for each geography independently, with continuing refinement done through new imagery, and through the incorporation of additional data sources. Each analytic procedure can be encapsulated into a geoprocessing model, allowing additional refinement and repetition of the process. The resulting processes combined can support the application of the methodology to any statistical dataset.

Furthermore, although the examples provide herein mostly refer to determining a distribution of a human population over a geographic area, it should be understood that the underlying concepts and algorithms can be broadly applied to many different scientific disciplines. For example, a temperature distribution can be determined over a geographic area based on geographic features (e.g., elevation, reflective properties of geographic features, surface properties (water, rock, vegetation, etc.) or other relevant information and additional ancillary data. In another example, a concentration of a particular drug in the blood stream of a test subject may be interpolated to determine relative concentrations across different portions of the body. For instance, certain organs may tend to store, attract, or accumulate the particular drug more than other structures of the body. These types of characteristics can be treated like “geographic features” in the distribution calculus. These examples should inform the great diversity in application of the methods and systems described herein.

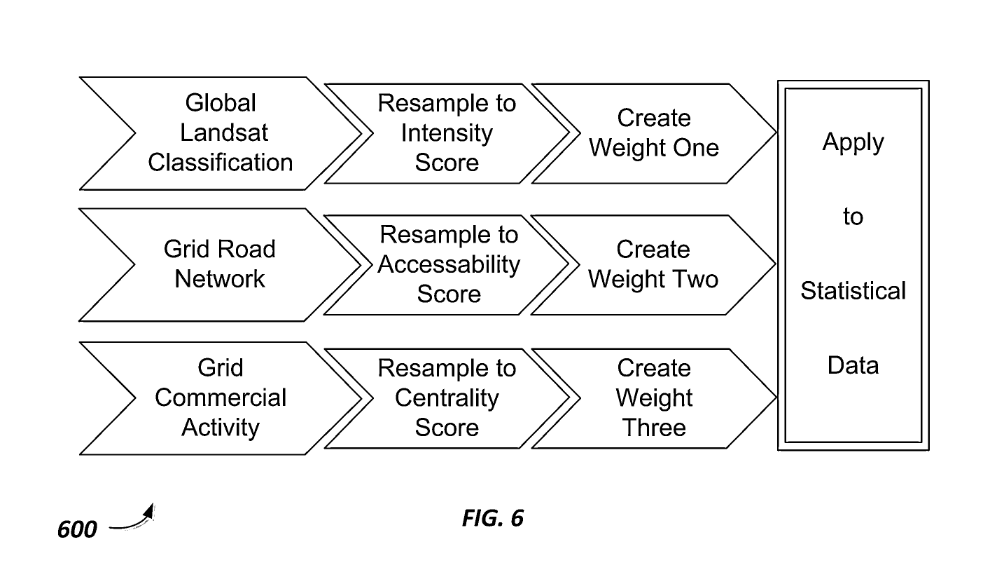

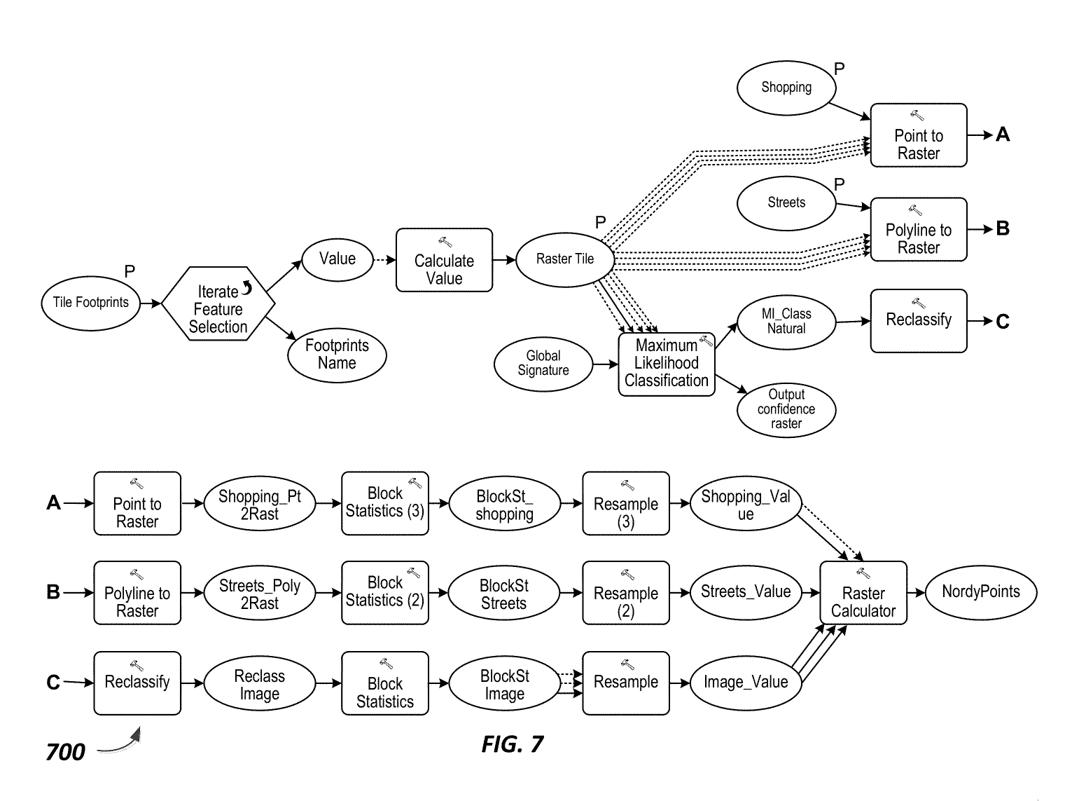

FIG. 6 is a simplified flow diagram illustrating a weight creation process utilizing common datasets to generate a distribution of a population over a geographic area using geographic features, a grid road network, and commercial activity, according to an embodiment of the invention. In some cases, the global landsat classification can relate to a geographic image can provide texture and variability in the model. For instance, there may be hills, valleys, bodies of water, buildings, structures, etc. The image can be classified (i.e., the geographic features thereof) and scored. In one example, the geographic features are scored from 0-55, with zero assigned to bodies of water and 55 to intensely urbanized areas. Furthermore, the road network can be classified in terms of a grid density and assigned a multiplier. For example, limited access roads may be assigned a multiplier of 1, while highly dense road networks can receive a multiplier of 5 to multiple with the image score classification. The commercial activity can be similarly scored to classify population centrality. The scoring and weighting can then be applied to the statistical data to determine a population density. FIG. 7 illustrates a more detailed flow diagram of FIG. 6, as would be appreciated by one of ordinary skill in the art with the benefit of this disclosure.

NordyPoints

As discussed above, two data components can be used to create the interpolated distributions described herein. The first data component can be a data set comprising a collection of social and demographic characteristics for a human population (e.g., a population). The second data component can be a gridded surface of the world, continent, region, or some subset thereof that can be used to predict the likelihood and density of the characteristics of the first data set (e.g., population) along each point, region, etc., of the gridded surface. In some cases, the gridded surface can be constructed from multiple datasets that can contribute to the accuracy of an aggregation/disaggregation approach. Thus, certain embodiments of the invention combine the two data components to calculate a numerical solution, or a “NordyPoint”(block centroid data), to any of a set of complex algorithms that calculate a particular discrete subset of a larger data set where the calculated particular subset equates to the localized portion of the larger data set. Different datasets may be used to calculate different NordyPoints, which can be generally referred to as Nordypoint(Nₓ), where N can be any integer and x represents some type of NordyPoint identification. The aggregate collection of all NordyPoints in a given geographical area can be referred to as NordyPoint(0ₓ), and may be equal to the known total particular data set of that region. It should be noted that NordyPoints are not limited to storing population data, as illustrated in FIGS. 1-7. NordyPoints may be calculated to hold a variety of demographic data including the nonexclusive list of medical data, disease occurrence, income level, and average spending, which can be represented as NordyPoints (0ₚₒₚᵤₗₐₜᵢₒₙ,0_{medical},0_{financial}). Alternatively, scientific data (or any other type of data) can be used in lieu of, or in combination with, the demographic data to generate a set of NordyPoints. In some embodiments, an implementation of NordyPoints can vary depending on the specific architecture of the underlying GIS system (e.g., ArcGIS platform). Some examples of NordyPoints can be seen in FIG. 4

In some aspects, calculating a NordyPoint can include creating a grid to overlay a certain predetermined geographical area and acquiring a data set containing information particular to the geographic region of interest. Then, using remote imagery interpolation techniques, the area encapsulated within each grid can be analyzed. A series of remote sensing equations can be used to apportion a specific portion of the total information to the area encapsulated within each of the grids. This apportioned data can be represented as a NordyPoint(Nₓ) and may be associated with a geographic point that is located in the center of each grid. In some cases, standard remote imagery interpolation techniques and remote sensing equations can be used, as would be appreciated by one of ordinary skill in the art with the benefit of this disclosure.

A set or multiple sets of NordyPoints may be created from any appropriate geographic data source. Those skilled in GIS will recognize that any number of unique techniques may be used to combine a set of NordyPoints into an aggregate NordyPoint(0ₓ). Additionally, it should be noted that a group of aggregate NordyPoints may be combined to form another aggregate NordyPoint. For example, NordyPoint(0₁) may be combined with NordyPoint(0₂) to form NordyPoint(0₀). It will also be understood by those skilled in GIS that a number of techniques may be used to combine NordyPoints and to apply the appropriate weight to either individual NordyPoints(Nₓ) or the members of a group of aggregate NordyPoints(0ₓ).

### EXAMPLE

### Population Analysis

To illustrate one implementation, basic demographic data may be compiled and forecast for a small areas, such as a Census block groups, and a methodology using NordyPoints (e.g., block centroid apportionment) is used to provide an accurate reaggregation of the data for any arbitrary geography. The methodology uses weights calculated for each of the block centroids (i.e., NordyPoints), which may include population, households, housing units, business weights, etc. These weights can then applied to the Census block group attributes to create an accurate calculation for any geography, be it a flood plain, projected natural disaster area, a drive time or any other arbitrary polygon.

For the United States, the calculation methodology may vary depending on the size of the geography for which the aggregation is being calculated. As such, a hierarchical approach can be used for larger areas where the appropriate aggregation can use larger units of geography if appropriate. In general, to speed calculations, a point aggregation technique can be used that provides consistent results and minimizes the number of calculations required.

In some embodiments, the block centroids (NordyPoints) and their weights can be defined by the Census geography, which, by definition, uses physical features to define the boundaries of a block. In some instances, this may then result in an irregular spacing of block centroids and require adjustments to the weights as new developments occur. For example, each year all household addresses are geocoded, resulting in adjustment of the block weights based on the identification of new household information in a previously defined block.

The aggregation and apportioning of individual attributes can be controlled by metadata for the attribute which includes a formula for complex calculations and identifies the weight on which to base the calculation. For attributes like means and medians, a base value may be needed and the formulas are also able to calculate margin of error in cases where the contributing attributes are created from survey data with known margins of error.

Each of these techniques may be consistently applied throughout the software suite and enable the creation of consistent reports and summary information. Some examples of implementation are through an online Software-as-a-Service (SaaS) application, a desktop, or a server and API implementations. It should be noted that these techniques can be extended to include additional data and the results can be consistent in all applications.

In some embodiments, the NordyPoint can be used is to store granular population data. Census reports often generalize population information for a region. In the United States, for example, population data from the census is reported for each county. A more granular view of the population distribution within a county may be calculated using a set of NordyPoints. In many cases, it is preferable to select a grid that is more granular than the most detailed dataset.

In the present example, the first set of population NordyPoints, which can be labeled NordyPoints(1ₚ), can be calculated by overlaying an equidistant grid over a geographic region containing one or more U.S. counties. The U.S. census population data for each of the covered counties is then acquired. Using one or more conventional remote imagery interpolation techniques, the area encapsulated within each grid is analyzed. Areas that are identified as containing high population sources, i.e., areas with houses and other structures, are weighted at a high level. Conversely, areas that are contain features that indicate low levels of population, i.e. forests and grasslands, streets, etc., are weighted lower level. This process may be repeated to any desired level of granularity dependent upon the sophistication of the underlying remote sensing algorithm. Some systems can be configured to identify over 100 or more different unique features and assign different weights to them. A NordyPoint is then calculated for each grid by calculating the sum of each included unique geographic feature and that features associated likelihood of population. This NordyPoint(1ₚ) is geographically associated with a geolocation located within the center of the before mentioned grid.

A second NordyPoint(2ₚ) may be calculated using the same census data and an analysis of the area's road density, for example. A grid is again laid out using remote imagery interpolation techniques to identify the density of streets within each grid. A weighting for each street density is created and used as a basis for apportioning the census population between each grid. The total apportioned population for each grid can be assigned as NordyPoint(2ₚ).

A third NordyPoint(3ₚ) may be calculated using a different underlying population data source such as a marketing database that reports population data by postal code. As with the calculation of NordyPoint(1p), remote imagery interpolation techniques keyed to geographical features may be used to apportion data to each chosen feature. The total apportioned population for each grid is then assigned as NordyPoint(3ₚ).

The collection of all NordyPoints (Nₓ) may then be calculated to obtain a NordyPoint(0) that can be more precise than any individual NordyPoint(Nₓ). Additionally, as new datasets are acquired, the system may calculate a NordyPoint or set of NordyPoints for that dataset and integrate those Nordypoints into the value of NordyPoint(0ₓ).

As described above, NordyPoints are not limited to storing population data. NordyPoints may incorporate a variety of demographic data, such as, but not limited to, data regarding populations, medical needs, and financial status. A set of such data can be represented as NordyPoints(0ₚₒₚᵤₗₐₜᵢₒₙ,0_{medicalNeeds}, 0_{fiancialStatus}).

In a further embodiment, another method for calculating the demographics of a given geographical area includes weighting the output from the imagery classification, scoring with the output from the road density, and scoring to create a single measure. This single measure (an arbitrary scale), can be representative of the modeled population density. This measure can be normalized to the statistical (demographic) data that is available at higher levels of geography. For example, with 3 NordyPoints of values 2, 5, 3, and a population figure from the statistical data of 100, the NordyPoint data can be normalized by assigning the population values of 20, 50, and 30 to the points, respectively.

### EXAMPLE

### Using Remote Sensing

In certain embodiments, a variety of standard GIS Remote Sensing techniques may be used to enhance the accuracy of each NordyPoint. For example, high resolution three dimension maps can be used in order to determine the relative occupancy of different buildings (e.g., high usage classification, higher weight, etc.). To illustrate, a single story house may occupy the same geographic land area as a multi-story apartment in a two-dimensional landscape. However, it is likely the house will only contain a few people while a multi-story apartment building can house many times that number. Any number of standard GIS techniques may be used to determine both the height and occupancy level of each building in a given area. Any combination of these techniques, as would be appreciated by those of ordinary skill in the art, may be used to create one or more sets of NordyPoints.

### EXAMPLE

### Resolution Equalizing

Typically, GIS data is not collected using a standardized minimum resolution scheme. This variance in demographic resolution schemes is a common trait when dealing with multiple sources of demographic data. However, greater accuracy is often obtainable by collating data from multiple sources. The present invention can accurately analyze multiple sources of combined GIS demographic data and integrate them without regard to their underlying minimum resolution scheme.

It will be recognized by skilled GIS professionals, that the creation of each NordyPoint will often involve the selection of a range of minimum resolution values. Greater consistency may, in some situations, be found when the minimum resolution number is consistent across all the data. However, it may be desirable to analyze data from multiple sources, where each source was collected at a different resolution level. Different resolution levels can be combined by selecting a NordyPoint resolution level lower than the lowest resolution level of any of the combined data sources. In an embodiment, a minimum resolution level for each NordyPoint that is arbitrarily lower than the lowest expected data resolution level can be implemented when the lowest resolution level of data is unknown or supplemental data is introduced at a later time. Alternatively, the system described herein can apply a “weighting” value to the NordyPoints collected at different resolution levels.

### EXAMPLE

### Portability

The portability and interoperability of NordyPoints is another advantage inherent to this technique. In some circumstances it is desirable to combine confidential data with data that is publicly available. One example of such a solution is that different sets of NordyPoints may be calculated for each set of confidential information. These NordyPoints may be then combined with NordyPoints created using less confidential information and reported in an appropriately secure manner.

### EXAMPLE

### Security

NordyPoints may also be calculated and stored in a way that appropriately reflects the sensitive nature of either the underlying data or the combined data which makes up a particular NordyPoint. In one aspect, NordyPoints may contain a privilege tag assigned to them by an appropriate authority. Such a NordyPoint may be represented as NordyPoints(N_{x,S}), where N is any integer, x represents some NordyPoint identification, and S is the security level of the NordyPoint. Any number of techniques, known by appropriate GIS professionals may be used to secure NordyPoints and restrict access to either individual NordyPoints, a set of calculated NordyPoints, or the results of a particular calculation.

Additional security measures may be implemented to protect sensitive NordyPoints from inadvertent disclosure. One protective non-limiting measure is to encrypt secure NordyPoints (individually or aggregated) and store them in an appropriate secure and encrypted state.

### EXAMPLE

### Crowd Sourcing

NordyPoints having different security settings can allows users to integrate their confidential information with publicly available data. Another advantage of this system is that it provides a granular and more easily managed method of integrating date from different sources into a GIS system. One example is the use of crowd sourced data that may be considered less reliable than the date collected by government sources. By using different security settings, the data can be marked at the appropriate trust level and integrated into the data set using appropriate techniques known by those of ordinary skill in the art.

Embodiments of the system may also be implemented to upgrade the security level of certain entered data either automatically or by authorized manual command. Those skilled in GIS will recognize many standard techniques whereby data collected in a crowd sourced manner may be validated using other crowd sourced techniques. Additionally, a number of hybrid techniques are well known that utilize both input from authorized users and crowd sources to apply the appropriate weight to specific data.

In some embodiments, one can separate the security functionality described from the data collection and validation system that has been described. Both of these methodologies may be implemented independently in a number of well understood ways. Additionally, certain combinations of both systems will be recognized by GIS professionals as advantageous to certain types of GIS users. These methods may utilize both proprietary and publicly available techniques of collection, calculation, and/or aggregation.

### EXAMPLE

### Mobile Solutions

The use of NordyPoints additionally allows those skilled in GIS to design a GIS system that contains pre-calculated NordyPoints. When a user collects new data this data can be readily added to the existing NordyPoint data by calculating solely the new NordyPoints associated with the collected data and any associated aggregate NordyPoints. Techniques known to GIS professionals may allow such techniques to be accomplished using low levels of processing power on a user's device. These techniques allow NordyPoints to be used on mobile devices. In some implementations, the mobile device may be used to collect the NordyPoint data. In other implementations, the mobile device may use techniques to integrate new NordyPoint data with previously calculated NordyPoint data. Each of these implementations, and others that use NordyPoints, provides users of mobile devices with a sought after solution for a portable GIS system. Additionally, where appropriate, certain processing tasks may be handled by a cloud computing system. This enables the deployment of a robust system despite the computational and storage limitations of many portable devices.

Customized Data Classification

The remote viewing techniques used by GIS professionals to classify different imagery sets may be adjusted using a variety of automated and user driven steps. This technique may be used to create a number of different NordyPoint(Nₓ) versions for each given data set. Different standard GIS and computer programing techniques may be used to sort these NordyPoints into different accuracy categories. The NordyPoint(Nₓ) for each grid area that is deemed to be the most accurate may be selected so that the final set of NordyPoint(Nₓ)s are a heterogeneous selection of different starting NordyPoints.

System Architectures

FIG. 8 illustrates a computer system 800 for generating a distribution of a population of a geographic area, according to an embodiment of the invention. The data processing, algorithms, and methods described herein (e.g., FIGS. 1 and 5) can be implemented within a computer system such as computer system 800 shown here. Computer system 800 can be implemented as any of various computing devices, including, e.g., a desktop or laptop computer, tablet computer, smart phone, personal digital assistant (PDA), or any other type of computing device, not limited to any particular form factor. Computer system 800 can include processing unit(s) 830, storage subsystem 810, input devices 850 (e.g., keyboards, mice, touchscreens, etc.), output devices 860 (e.g., displays, speakers, tactile output devices, etc.), network interface 870 (e.g., RF, 4G, EDGE, WiFi, GPS, Ethernet, etc.), and bus 805 to communicatively couple the various elements of system 800 to one another.

Processing unit(s) 830 can include a single processor, multi-core processor, or multiple processors and may execute instructions in hardware, firmware, or software, such as instructions stored in storage subsystem 810. The storage subsystem 810 can include various memory units such as a system memory, a read-only memory (ROM), and permanent storage device(s) (e.g., magnetic, solid state, or optical media, flash memory, etc.). The ROM can store static data and instructions required by processing unit(s) 830 and other modules of the system 800. The system memory can store some or all of the instructions and data that the processor needs at runtime.

In some embodiments, storage subsystem 810 can store one or more of data or software programs to be executed by processing unit(s) 830, such as the geographic data 812, the demographic data 814, or the interpolation subroutines 816, as further described above with respect to FIGS. 1-7. As mentioned, “software” can refer to sequences of instructions that, when executed by processing unit(s) 830, cause computer system 800 to perform certain operations of the software programs. The instructions can be stored as firmware residing in read-only memory and/or applications stored in media storage that can be read into memory for processing by processing unit(s) 830. Software can be implemented as a single program or a collection of separate programs and can be stored in non-volatile storage and copied in whole or in part to volatile working memory during program execution. From storage subsystem 810, processing unit(s) 830 can retrieve program instructions to execute in order to execute various operations (e.g., interpolations) described herein.

It will be appreciated that computer system 800 is illustrative and that variations and modifications are possible. Computer system 800 can have other capabilities not specifically described here (e.g., mobile phone, global positioning system (GPS), power management, one or more cameras, various connection ports for connecting external devices or accessories, etc.). Further, while computer system 800 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Aspects of system 800 may be implemented in many different configurations. In some embodiments, system 800 may be configured as a distributed system where one or more components of system 800 are distributed over one or more networks in the cloud. FIG. 9 depicts a simplified diagram of a distributed system 900 for providing a system and method for generating a distribution of a population over a geographic area, according to an embodiment of the invention. In the embodiment depicted in FIG. 9, system 900 is provided on a server 902 that is communicatively coupled with one or more remote client devices 910, 920, 930 via network 906.

Network 906 may include one or more communication networks, which could be the

Internet, a local area network (LAN), a wide area network (WAN), a wireless or wired network, an Intranet, a private network, a public network, a switched network, or any other suitable communication network or combination thereof. Network 906 may include many interconnected systems and communication links including but not restricted to hardwire links, optical links, satellite or other wireless communications links, wave propagation links, or any communication protocol. Various communication protocols may be used to facilitate communication of information via network 906, including but not restricted to TCP/IP, HTTP protocols, extensible markup language (XML), wireless application protocol (WAP), protocols under development by industry standard organizations, vendor-specific protocols, customized protocols, and others as would be appreciated by one of ordinary skill in the art. In the configuration depicted in FIG. 9, aspects of system 800 may be displayed on any of client devices 910, 920, 930.

In the configuration depicted in FIG. 9, system 800 is remotely located from client devices 910, 920, 930. In some embodiments, server 902 may perform the methods of determining (or interpolating) a population over a geographic area described herein. In some embodiments, the services provided by server 902 may be offered as web-based or cloud services or under a Software as a Service (SaaS) model, as would be appreciated by one of ordinary skill in the art.

While the invention has been described with respect to specific embodiments, one skilled in the art will recognize that numerous modifications are possible. Thus, although the invention has been described with respect to specific embodiments, it will be appreciated that the invention is intended to cover all modifications and equivalents within the scope of the following claims.

The above disclosure provides examples and aspects relating to various embodiments within the scope of claims, appended hereto or later added in accordance with applicable law. However, these examples are not limiting as to how any disclosed aspect may be implemented.

All the features disclosed in this specification (including any accompanying claims, abstract, and drawings) can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, sixth paragraph. In particular, the use of “step of” in the claims herein is not intended to invoke the provisions of 35 U.S.C. §112, sixth paragraph.

What is claimed is:

1. A computer-implemented method comprising:
receiving geographic data corresponding to a geographic area, wherein the geographic area includes geographic features;
receiving population data corresponding to a population of the geographic area; and
generating a distribution of the population over the geographic area based on characteristics of the geographic features.

2. The method of claim 1 further comprising:
classifying the characteristics of the geographic features using one or more usage categories, wherein the usage categories correspond to an estimated population density associated with the particular geographic feature.

3. The method of claim 2 further comprising:
generating a grid configured to overlay the geographic area, the grid comprising a plurality of grid lines forming a plurality of grid cells there between; and
interpolating a distribution of the population to an area encapsulated within each of the plurality of grid cells based on the usage categories of the geographic features and a position of the geographic features with respect to each of the plurality of grid cells.

4. The method of claim 3, wherein the distribution of the population to the area encapsulated within each of the plurality of grid cells is represented by a point with a size that is proportional to a magnitude of the population within the particular grid cell.

5. The method of claim 3 further comprising:
receiving road-based data including a location and density of a plurality of roads within the geographic area, wherein interpolating a distribution of the population to an area encapsulated within each of the plurality of grid cells is further based on the location and density of the plurality of roads with respect to each of the plurality of grid cells.

6. The method of claim 5 further comprising:
assigning a first weighted value to one or more of the geographic features; and
assigning a second weighted value to the plurality of roads, wherein interpolating the distribution of the population is further based on the associated weighted values of the geographic features and the plurality of roads.

7. The method of claim 5 further comprising:
receiving commercial activity data indicating intensities of commercial activity within the geographic area, wherein interpolating a distribution of the population to an area encapsulated within each of the plurality of grid cells is further based on both a location and intensity of commercial activity with respect to each of the plurality of grid cells.

8. The method of claim 7 further comprising:
assigning a third weighted value to the commercial activity, wherein interpolating the distribution of the population is further based on the associated weighted value of the commercial activity.

9. The method of claim 5 further comprising:
receiving demographic data indicating an intensity of a population demographic over the geographic area, wherein interpolating a distribution of the population to an area encapsulated within each of the plurality of grid cells is further based on both a location and intensity of demographic with respect to each of the plurality of grid cells.

10. The method of claim 9, wherein the population demographic includes one of gender, race, age, disabilities, mobility, home ownership, employment status, income level, and average spending.

11. A non-transitory computer readable medium comprising software code executable by a processor, the software code comprising:
software code for receiving geographic data corresponding to a geographic area, wherein the geographic area includes geographic features;
software code for receiving population data corresponding to a population of the geographic area; and
software code for generating a distribution of the population over the geographic area based on characteristics of the geographic features.

12. The non-transitory computer readable medium of claim 11 further comprising:
software code for classifying the characteristics of the geographic features using one or more usage categories, wherein the usage categories correspond to an estimated population density associated with the particular geographic feature.

13. The non-transitory computer readable medium of claim 12 further comprising:
software code for generating a grid configured to overlay the geographic area, the grid comprising a plurality of grid lines forming a plurality of grid cells there between; and
software code for interpolating a distribution of the population to an area encapsulated within each of the plurality of grid cells based on the usage categories of the geographic features and a position of the geographic features with respect to each of the plurality of grid cells.

14. The non-transitory computer readable medium of claim 13 wherein the distribution of the population to the area encapsulated within each of the plurality of grid cells is represented by a point with a size that is proportional to magnitude of the population associated within the particular grid cell.

15. The non-transitory computer readable medium of claim 11 further comprising:
software code for receiving road-based data including a location and density of a plurality of roads within the geographic area, wherein interpolating a distribution of the population to an area encapsulated within each of the plurality of grid cells is further based on the location and density of the plurality of roads with respect to each of the plurality of grid cells.

16. The non-transitory computer readable medium of claim 15 further comprising:
assigning a first weighted value to one or more of the geographic features; and
assigning a second weighted value to the plurality of roads, wherein interpolating the distribution of the population is further based on the associated weighted values of the geographic features and the plurality of roads.

17. A computer program product stored on a non-transitory computer-readable storage medium comprising computer-executable instructions causing a processor to:
receive geographic data corresponding to a geographic area, wherein the geographic area includes geographic features;
receive population data corresponding to a population of the geographic area; and
generate a distribution of the population over the geographic area based on characteristics of the geographic features.

18. The computer program product of claim 17 further comprising computer-executable instructions causing a processor to:
classify the characteristics of the geographic features using one or more usage categories, wherein the usage categories correspond to an estimated population density associated with the particular geographic feature.

19. The computer program product of claim 18 further comprising computer-executable instructions causing a processor to:
generate a grid configured to overlay the geographic area, the grid comprising a plurality of grid lines forming a plurality of grid cells there between; and
interpolate a distribution of the population to an area encapsulated within each of the plurality of grid cells based on the usage categories of the geographic features and a position of the geographic features with respect to each of the plurality of grid cells.

20. The computer program product of claim 19 further comprising computer-executable instructions causing a processor to:
receive road-based data including a location and density of a plurality of roads within the geographic area, wherein interpolating a distribution of the population to an area encapsulated within each of the plurality of grid cells is further based on the location and density of the plurality of roads with respect to each of the plurality of grid cells.
